(19) United States
(12) Patent Application Publication
(10) Pub. No.: US 2005/0187751 A1
(43) Pub. Date: Aug. 25, 2005

(54) Evaluation system, evaluation method and evaluation program using device simulation and circuit simulation

(75) Inventor: Kazuya Matsuzawa, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/045,306

(22) Filed: Jan. 31, 2005

(30) Foreign Application Priority Data
Feb. 24, 2004 (JP) 2004-048270

(51) Int. Cl. G06F 17/50

(52) U.S. Cl. 703/14

(57) ABSTRACT

A method for evaluating a semiconductor integrated circuit, includes executing device simulation to acquire device simulation values, executing circuit simulation to acquire circuit simulation values of the semiconductor integrated circuit by generating a net list using the device simulation values, and repeating device simulation and circuit simulation until differences between the device simulation values and the circuit simulation values of the connection nodes satisfy judgment conditions so as to set conditions of device simulation employing the circuit simulation values.

### CROSS REFERENCE TO RELATED APPLICATIONS AND INCORPORATION BY REFERENCE

This application is based upon and claims the benefit of priority from prior Japanese Patent Application P2004-048270 filed on Feb. 24, 2004; the entire contents of which are incorporated by reference herein.

### BACKGROUND OF THE INVENTION

1. Field of the Invention

The present invention relates to a system, a method and a program for evaluating a semiconductor integrated circuit.

2. Description of the Related Art

Soft errors occur in a static random access memory (SRAM), latch circuits and the like due to integration of a semiconductor integrated circuit (LSI). “Soft error” refers to a phenomenon in which current flows through a semiconductor substrate due to electron-hole pairs induced by alpha-rays and neutron beams, which are incident on the semiconductor substrate, causing malfunction of semiconductor devices. In general, the frequency of soft error occurrences is low. Therefore, in order to investigate influences of soft error on circuits, field tests, experiments by acceleration tests and the like, estimations of influences on LSI by analysis (hereinafter referred to as “simulation”) by computer, and clarification of mechanisms of soft error occurrence are necessary. In order to analyze (hereinafter referred to as “simulate”) detailed motions of the electron-hole pair induced in the semiconductor substrate by the incidence of the α-ray and the neutron beam thereonto, a device analysis including device simulation needs to be executed.

However, device information necessary for device simulation is generally substantial. Therefore, several devices cannot be simultaneously simulated by device simulation. Accordingly, the simulations of the influence on circuits by induced electrons and holes need to be in conjunction with a circuit analysis including a circuit simulation for simulating many device operations simultaneously. First, in order to estimate the operation of the circuit precisely in contemplation with the influence of induced electrons and holes, a noise waveform appearing at a terminal of the device due to the incidence of the alpha ray and the neutron beam is obtained by device simulation. Then, the influence of the noise waveform on the operation of the circuit is calculated by circuit simulation.

Technology to allow device simulation and circuit simulation to be conducted in conjunction with each other, a mixed mode method, has been proposed. In the mixed mode method, a circuit to be subjected to a circuit simulation is modeled so that the circuit will be an object of a device simulation, and is incorporated in a device simulation model to be subjected to device simulation.

However, in the mixed mode method, it is difficult to simulate a circuit including many devices as in the case of a general device simulation. Furthermore, a large number of portions of a device simulation system including an entering unit and a calculation unit, which executes device simulation, needs to be extensively modified.

### SUMMARY OF THE INVENTION

The present invention may provide an evaluation method, an evaluation system and an evaluation program, which allow a device simulation and circuit simulation to be conducted in conjunction with each other, and which are capable of simulating a circuit with high precision.

An aspect of the present invention inheres in a computer implemented method for evaluating a semiconductor integrated circuit, including executing a device simulation of a plurality of devices included in a semiconductor integrated circuit based on device information of the devices to acquire device simulation values; executing a circuit simulation to acquire circuit simulation values of the semiconductor integrated circuit by generating a net list using the device simulation values as values of a power supply of connection nodes based on circuit information of the semiconductor integrated circuit and connection node information; and repeating the device simulation and the circuit simulation until differences between the device simulation values and the circuit simulation values of the connection nodes satisfy judgment conditions, so as to set conditions of the device simulation employing the circuit simulation values for the values of the power supply of the connection nodes.

Another aspect of the present invention inheres in a system for evaluating a semiconductor integrated circuit, including a device simulator configured to execute a device simulation of a plurality of devices included in a semiconductor integrated circuit based on device information of the devices to acquire device simulation values; a circuit simulator configured to execute a circuit simulation to acquire circuit simulation values of the semiconductor integrated circuit by generating a net list using the device simulation values as values of power supply of connection nodes based on circuit information of the semiconductor integrated circuit and connection node information; and a convergence judgment module configured to judge on determines whether differences between the device simulation values and the circuit simulation values of the connection nodes satisfy judgment conditions and to repeat the device simulation and the circuit simulation until the differences satisfy the judgment conditions, so as to set conditions of the device simulation employing the circuit simulation values as the values of the power supply of the connection nodes.

Still another aspect of the present invention inheres in a computer program product for evaluating a semiconductor integrated circuit, including instructions configured to execute a device simulation of a plurality of devices included in a semiconductor integrated circuit based on device information of the devices to acquire device simulation values; instructions configured to execute a circuit simulation to acquire circuit simulation values of the semiconductor integrated circuit by generating a net list using the device simulation values as values of power supply of connection nodes based on circuit information of the semiconductor integrated circuit and connection node information; and instructions configured to repeat the device simulation and the circuit simulation until differences between the device simulation values and the circuit simulation values of the connection nodes satisfy judgment conditions, so as to set conditions of the device simulation employing the circuit simulation values as the values of the power supply of the connection nodes.

### BRIEF DESCRIPTION OF DRAWINGS

FIG. 1 is a schematic view showing an evaluation system according to a first embodiment of the present invention;

FIG. 2 is a schematic view showing an example in which of a space occupied by a device that will be evaluated by an evaluation method according to the first embodiment of the present invention is divided into the form of a lattice;

FIG. 3A is a schematic circuit explaining information of a connection node used in the evaluation method according to the first embodiment of the present invention;

FIG. 3B is a schematic view explaining a connection node information used for the evaluation method according to the first embodiment of the present invention;

FIG. 4 is a flowchart explaining the evaluation method according to the first embodiment of the present invention;

FIG. 5 is a schematic circuit explaining the evaluation method according to the first embodiment of the present invention;

FIG. 6 is a graph showing the evaluation result of the circuit shown in FIG. 5 obtained by the evaluation method according to the first embodiment of the present invention;

FIG. 7 is a schematic view showing an evaluation system according to a second embodiment of the present invention;

FIG. 8 is a schematic view explaining an interpolation calculation of the evaluation method according to the second embodiment of the present invention;

FIG. 9 is a flowchart explaining the evaluation method according to the second embodiment of the present invention;

FIG. 10 is a schematic view showing an evaluation system according to a third embodiment of the present invention;

FIG. 11 is a flowchart explaining the evaluation method according to the third embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### First Embodiment

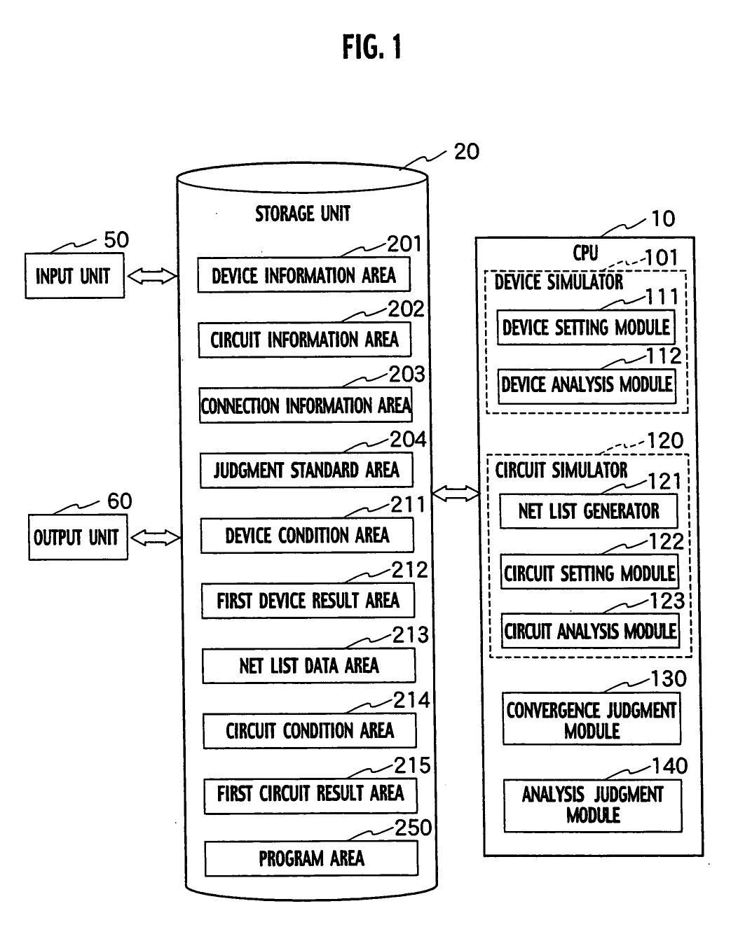

An evaluation system according to a first embodiment of the present invention illustrated in FIG. 1 includes a central processing unit (CPU) 10, a storage unit 20, an input unit 50 and an output unit 60.

The CPU 10 includes a device simulator 101 to execute a device simulation of a plurality of devices included in the semiconductor circuit based on device information of the devices to acquire a set of device simulation values, a circuit simulator 120 to execute a circuit simulation to acquire circuit simulation values of the semiconductor integrated circuit by generating a net list using the device simulation values as values of power supply of connection nodes based on circuit information of the semiconductor integrated circuit and connection node information, and a convergence judgment module 130 to judge on determines whether differences between the device simulation values and the circuit simulation values of the connection nodes satisfy judgment conditions and to repeat the device simulation and the circuit simulation until the differences satisfy the judgment conditions, so as to set conditions of the device simulation employing the circuit simulation values as the values of the power supply of the connection nodes. And the CPU 10 includes an analysis judgment module 140 to judge on determine completion of a simulation.

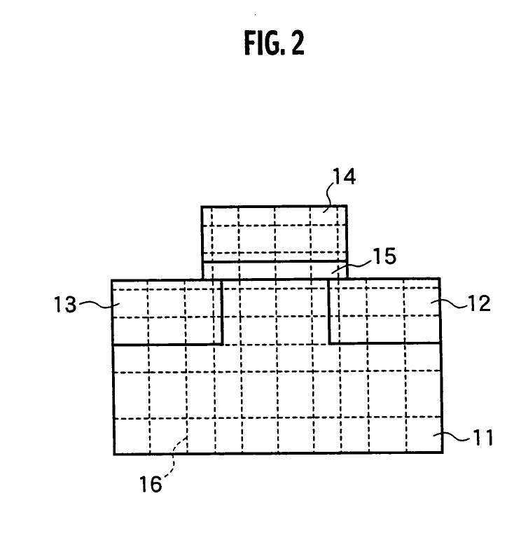

The device simulator 101 includes a device setting module 111 and a device analysis module 112. The device setting module 111 performs a setting operation necessary for an execution of device simulation based on device information read from a device information area 201. To be specific, the device setting module 111 divides a space, which is occupied by a device which is an object to be simulated, into the form of a lattice, and executes device simulation for each lattice point. FIG. 2 illustrates a section view of an example in which a space occupied by a MOS transistor having a substrate 11, a drain electrode 12, a source electrode 13, a gate electrode 14 and a gate insulating film 15 is divided into a lattice. A lattice 16 is illustrated by the dotted lines in FIG. 2. In addition, the device setting module 111 sets substance information including an impurity concentration in each lattice point, a dielectric constant, a work function, and the like. Furthermore, the device setting module 111 sets conditions for executing device simulation, which include a bias condition, a time, and the like. The device analysis module 112 executes device simulation based on the conditions set by the device setting module 111, and acquires device simulation values. Specifically, the device analysis module 112 solves a Poisson equation, a current continuity equation, and the like, and calculates a voltage value of each lattice point and a carrier concentration of electrons, holes, and the like, in each lattice point. Then, the device analysis module 112 calculates a current value of each lattice point based on the calculated voltage value and carrier concentration as well as based on an equation of a current density.

The circuit simulator 120 includes a net list generator 121, a circuit setting module 122 and a circuit analysis module 123. The net list generator 121 generates a net list based on information of a semiconductor integrated circuit read from a circuit information area 202. The term “Net list” refers to connection information of a plurality of devices included in the semiconductor integrated circuit. The circuit setting module 122 sets conditions for executing the circuit simulation by generating a nodal equation satisfying Kirchhoff's law based on the net list generated by the net list generator 121. The circuit analysis module 123 analyzes characteristics of the semiconductor integrated circuit. The circuit analysis module 123 solves the nodal equation generated by the circuit setting module 122, and analyzes a voltage value in each nodal point and a current value between the nodal points. The term “Nodal Point” refers to a connection node between devices included in the net list, for example, a connection node between transistors.

The convergence judgment module 130 calculates differences between simulation values respectively calculated by device simulation and circuit simulation, and judges on determines whether the difference between the simulation values satisfies a judgment on determination read from a judgment standard area 204. Subsequently, when the difference satisfies the judgment condition, device simulation and circuit simulation have been converged, a circuit evaluation result is judged to be proper. When the difference does not satisfy the judgment condition, a device simulation using circuit simulation values and a circuit simulation using the device simulation values are repeatedly executed until the differences between the device simulation values and the circuit simulation values satisfy the judgment condition.

The analysis judgment module 140 judges on determines whether simulations in all bias conditions and at all times, which are set by the device setting module 111, have been completed.

The storage unit 20 includes the device information area 201, the circuit information area 202, a connection information area 203, a judgment standard area 204, a device condition area 211, a first device result area 212, a net list data area 213, a circuit condition area 214, a first circuit result area 215 and a program area 250.

Device information such as a structure of the device, which is an object to be simulated, is stored in the device information area 201. Circuit information such as electrical connection information of the semiconductor integrated circuit, which is an object to be simulated, is stored in the circuit information area 202. Connection node information of device simulation and circuit simulation is stored in the connection information area 203. Descriptions of the connection node information will be made later. A judgment condition for judging whether the circuit evaluation result is proper is stored in the judgment standard area 204. A setting for executing device simulation is stored in the device condition area 211. The device simulation values calculated by device simulation are stored in the first device result area 212. A net list for executing circuit simulation is stored in the net list area 213. A setting for executing circuit simulation is stored in the circuit condition area 214. The circuit simulation values calculated by circuit simulation are stored in the first circuit result area 215. A device simulation program, a circuit simulation program, a program managing the device simulation values, the circuit simulation values, and the like are stored in the program area 250.

Device information, which is an object to be simulated, circuit information of the semiconductor integrated circuit for which circuit simulation is executed, and the like are read via the input unit 50, and stored in the storage unit 20. The input unit 50 may be implemented by a keyboard, a mouse, a write pen, a flexible disc device, and the like. A person who executes the circuit evaluation assigns input/output data through the input unit 50, and can set simulation conditions such as temperature and error. This person can also set simulation parameters such as the form of the input/output data through the input unit 50, and can input an instruction for instructing an execution, a stop and the like of the simulation therethrough.

As the output unit 60, a display displaying the simulation result, a printer or a recording device capable of storing the simulation result in a computer-readable recoding medium can be used. Herein, the term “Computer-Readable Recording Medium” refers to a medium capable of recording electronic data, which includes an external memory device of a computer, a semiconductor memory, a magnetic disk, an optical disk, a magneto-optical disk, a magnetic tape, and the like. To be concrete, a flexible disk, a CD-ROM, an MO disk a cassette tape, an open reel tape and the like are included in the “computer-readable recording medium”.

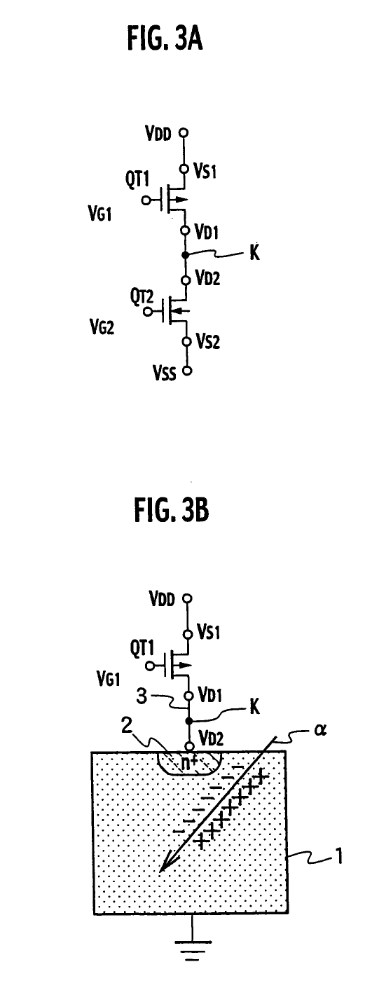

In the semiconductor integrated circuit, a point where a device which is an object to be simulated and other devices are connected is referred to as a “connection node” hereinafter. An example of the connection node will be described by use of FIGS. 3A and 3B. An inverter circuit constituted by a p-channel MOS (hereinafter referred to as pMOS) transistor QT1 and an n-channel MOS (hereinafter referred to as nMOS) transistor QT2 is illustrated in FIG. 3A. A power supply terminal V_{DD} is connected to a source electrode V_{S1} of the pMOS transistor QT1, and a drain electrode V_{D2} of the nMOS transistor QT2 is connected to a drain electrode V_{D1}. Furthermore, a power supply terminal V_{SS} is connected to a source electrode V_{S2} of the nMOS transistor QT2. Other devices (not shown) are connected to a gate electrode V_{G1} of the pMOS transistor QT1, a gate electrode V_{G2} of the nMOS transistor QT2, the drain electrode V_{D1} of the pMOS transistor QT1, and the drain electrode V_{D2} of the nMOS transistor QT2, respectively.

A section view of an active region 1 of a semiconductor substrate where the drain electrode 2 of the nMOS transistor QT2 illustrated in FIG. 3A, and a circuit diagram of the pMOS transistor QT1 are illustrated in FIG. 3B. For example, when influences are generated by electron-hole pairs by incidence of alpha-rays on the active region 1 illustrated in FIG. 3B, on the inverter circuit illustrated in FIG. 3A, are evaluated by use of the evaluation system illustrated in FIG. 1, a device simulation of the nMOS transistor QT2 is first executed.

Accordingly, as illustrated in FIGS. 3A and 3B, an optional position of the wiring 3 connecting the drain electrode V_{D1} of the pMOS transistor QT1 and the drain electrode V_{D2} of the nMOS transistor QT2 is a connection node K. In general, the wiring 3 is not an object of device simulation. Therefore, the drain electrode V_{D2} of the nMOS transistor QT2, for example, is the connection node K Next, a net list is generated by use of a current value calculated by device simulation as a value of a current supply of the connection node K, and then circuit simulation of the semiconductor integrated circuit is executed.

As described above, a lattice point of the drain electrode V_{D2} of the nMOS transistor QT2 in device simulation is the connection node K. In addition, when circuit simulation is executed, a nodal point where the drain electrode VD1 of the pMOS transistor QT1 and the drain electrode VD2 of the nMOS transistor QT2 are connected is the connection node K. Information of the lattice point and the nodal point, which correspond to the connection node, is referred to as “connection node information”. By referring to the connection node information, information of the lattice point calculated by device simulation is used as information of the nodal point used for circuit simulation. Furthermore, the information of the nodal point calculated by circuit simulation is used as information of the lattice point used for device simulation.

Generally, in device simulation, a simulation is executed by using a voltage value as a boundary condition, and a current value of each lattice point is calculated. Furthermore, in circuit simulation, a simulation is executed by using a current value as a boundary condition, and a voltage value of each nodal point is calculated. The “boundary condition” is an initial value when the simulation is executed. The evaluation system illustrated in FIG. 1 uses a current value of a connection node calculated by device simulation as a boundary condition in circuit simulation. In addition, voltage value of the connection node calculated by circuit simulation is used as a boundary condition in device simulation if needed. For example, circuit simulation of the inverter circuit illustrated in FIG. 3A is executed, and a voltage value of the drain electrode V_{D2} of the nMOS transistor QT2 is calculated. Subsequently, device simulation of the nMOS transistor QT2 is executed by using the calculated voltage value as a value of a voltage supply of a lattice point of the drain electrode V_{D2} of the nMOS transistor QT2.

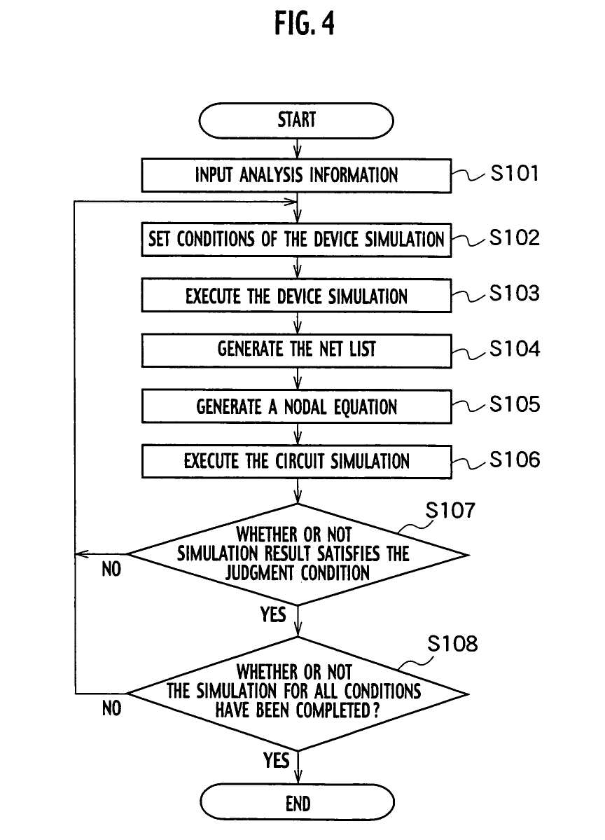

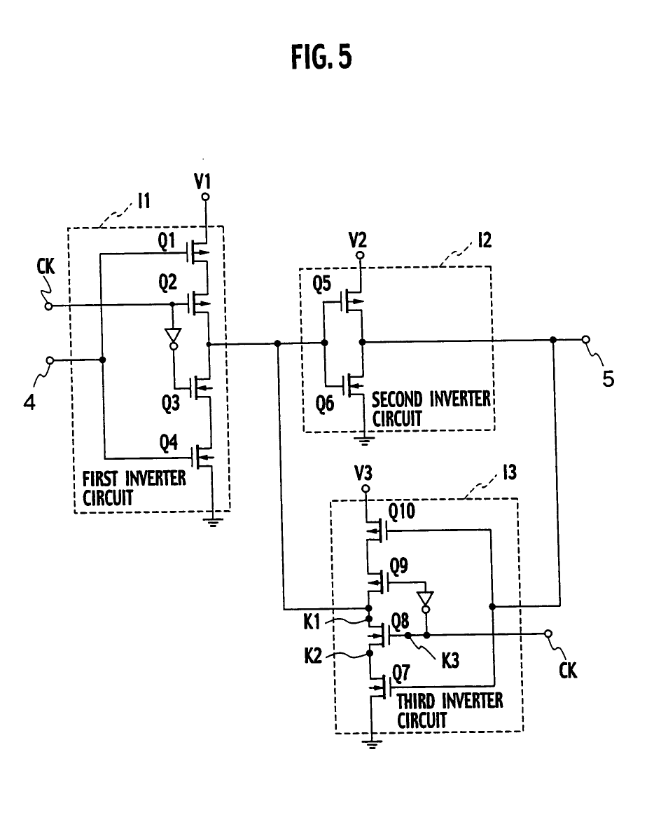

Next, an example of a method of evaluating the semiconductor integrated circuit by the evaluation system illustrated in FIG. 1 will be described by use of a flowchart illustrated in FIG. 4. In the following descriptions, an example of evaluating a circuit illustrated in FIG. 5 will be described.

First, the circuit illustrated in FIG. 5 will be described. The circuit illustrated in FIG. 5 is a latch circuit constituted by a pMOS transistor and an nMOS transistor. An input terminal 4 is connected to a first inverter circuit I1. The first inverter circuit I1 is connected to a power supply terminal V1, and controlled by clock signals supplied through a clock terminal CK. The clock signals are delivered from a clock signal generating circuit (not shown). The first inverter circuit I1 is constituted by a pMOS transistor Q1, a pMOS transistor Q2, an nMOS transistor Q3 and an nMOS transistor Q4.

An output of the first inverter circuit I1 is supplied to a second inverter circuit I2 connected to a power supply terminal V2. The second inverter circuit I2 is constituted by a pMOS transistor Q5 and an nMOS transistor Q6. An output of the second inverter circuit I2 is supplied to an output terminal 5 and a third inverter circuit I3.

The third inverter circuit I3 is connected to a power supply terminal V3, and controlled by the clock signals supplied through the clock terminal CK. The third inverter circuit I3 is constituted by an nMOS transistor Q7, an nMOS transistor Q8, a pMOS transistor Q9 and a pMOS transistor Q10. Furthermore, an output of the third inverter circuit I3 is supplied to the second inverter circuit I2.

Herein, when alpha-rays are incident on an active region of a semiconductor substrate where a drain electrode of the nMOS transistor Q8 is formed, an example of evaluating the latch circuit illustrated in FIG. 5 will be described. Specifically, the nMOS transistor Q8 and the pMOS transistor Q9 illustrated in FIG. 5 correspond to the nMOS transistor QT1 and the pMOS transistor QT2 illustrated in FIGS. 3A and 3B, respectively. Device simulation is executed for the nMOS transistor Q8. Then, a connection node where the drain electrode of the nMOS transistor Q8 and a drain electrode of the pMOS transistor Q9 are connected will be a connection node K1, a connection node where a source electrode of the nMOS transistor Q8 and a drain electrode of the nMOS transistor Q7 are connected will be a connection node K2, and a connection node where a gate electrode of the nMOS transistor Q8 and the clock terminal CK are connected will be a connection node K3.

In a Step S101 illustrated in FIG. 4, device information of the nMOS transistor Q8, circuit information of the latch circuit illustrated in FIG. 5, connection node information and judgment conditions are received through the input unit 50 illustrated in FIG. 1, and are respectively stored in the device information area 201, the circuit information area 202, the connection information area 203 and the judgment standard area 204.

In a Step S102, the device setting module 111 reads the device information of the nMOS transistor Q8 stored in the device information area 201. Then, the device setting module 111 sets conditions of device simulation. The conditions which have been set are stored in the device condition area 211.

In a Step S103, the device analysis module 112 reads the conditions stored in the device condition area 211. Subsequently, the device analysis module 112 executes device simulation of the nMOS transistor Q8. Current value and voltage value of each lattice point of the nMOS transistor Q8, which have been calculated by device simulation, are stored in the first device result area 212.

In a Step S104, the net list generator 121 reads the connection node information stored in the connection information area 203 and current value of each lattice point of the nMOS transistor Q8, which has been stored in the first device result area 212. Then, the net list generator 121 extracts current values of the lattice points of the nMOS transistor Q8, which correspond to the connection nodes K1, K2 and K3, from current values of the respective lattice points of the nMOS transistor Q8, based on the connection node information. Subsequently, the net list generator 121 reads the circuit information of the latch circuit stored in the circuit information area 202. Then, the net list generator 121 generates the net list by using the extracted current values as values of current supply source of the nodal points of the latch circuit corresponding to the connection nodes K1, K2 and K3, based on the connection node information and the circuit information of the latch circuit. The generated net list is stored in the net list area 213.

In a Step S105, the circuit setting module 122 reads the net list stored in the net list data area 213. Then, the circuit setting module 122 generates a nodal equation of the latch circuit based on the net list. The generated nodal equation is stored in the circuit condition area 214.

In a Step S106, the circuit analysis module 123 reads the nodal equation stored in the circuit condition area 214. Then, the circuit analysis module 123 solves the nodal equation, and calculates voltage values of respective nodal points of the latch circuit and current values between nodal points thereof. Calculated voltage values of the respective nodal points and calculated current values between the nodal points thereof are stored in the first circuit result area 215.

In a Step 107, the convergence judgment module 130 reads voltage values of the lattice points of the nMOS transistor Q8 stored in the first device result area 212, voltage value of the nodal points of the latch circuit stored in the first circuit result area 215, and the connection node information stored in the connection information area 203. The convergence judgment module 130 compares the difference between voltage values in the connection nodes K1, K2 and K3, which are calculated by device simulation and circuit simulation, with judgment conditions read from the judgment standard area 204, based on connection node information. Judgment conditions can be set to be, for example, about 10 mV or less. If the difference between compared voltage values satisfies judgment conditions, the procedure progresses to a Step S108. If the difference between the compared voltage values does not satisfy the judgment condition, voltage values and current values of the connection nodes K1, K2 and K3, which are calculated in circuit simulation, are stored in the device condition area 211. Subsequently, the procedure progresses to the Step S103, device simulation of the nMOS transistor Q8 is executed by use of voltage values of the connection nodes K1, K2 and K3 stored in the device condition area 211 as a value of voltage supply of the lattice points corresponding thereto.

In the Step S108, the analysis judgment module 140 reads information of the device information area 201. Then, the analysis judgment module 140 judges whether the simulations for all bias conditions and for all times have been completed. If the simulations have not been completed, the procedure returns to the Step S103, and device simulation for the bias condition and the time, which have not been subjected to device simulation, is executed. If the simulations for all bias conditions and the times have been already completed, the simulation result stored in the first device result area 212 and the simulation result stored in the first circuit result area 215 are outputted via the output unit 60, and the evaluation is finished.

As described above, in circuit simulation, circuit simulation of the latch circuit using current values of the connection nodes K1, K2 and K3 as a device simulation result is executed. Then, device simulation of the nMOS transistor Q8 is executed by use of voltage values of the connection nodes K1, K2 and K3 as a circuit simulation result. Device simulation and circuit simulation are repeatedly executed until the difference between voltage values respectively calculated by device simulation and circuit simulation satisfy judgment conditions.

In the above descriptions, an example was shown in which current values of the connection nodes K1, K2 and K3 obtained by device simulation were used as values of voltage supplies of nodal points in circuit simulation, and voltage values of the connection nodes K1, K2 and K3 obtained by circuit simulation were used ad the values of current supplies of the lattice points in device simulation. However, it is also possible to use voltage values of the connection nodes K1, K2 and K3 obtained by device simulation as voltage supplies of the nodal points in circuit simulation, and it is also possible to use current values of the connection nodes K1, K2 and K3 obtained by circuit simulation as values of current supplies of lattice points in circuit simulation.

Furthermore, the example was shown, in which the difference between voltage values of the connection nodes K1, K2 and K3 respectively calculated by device simulation and circuit simulation was judged. However, the difference between current values of the connection nodes K1, K2 and K3 respectively calculated by device simulation and circuit simulation can be also used as judgment conditions. When the judgment condition is the difference between current values, it is possible to adopt a value equal to, for example, 1 pA or less.

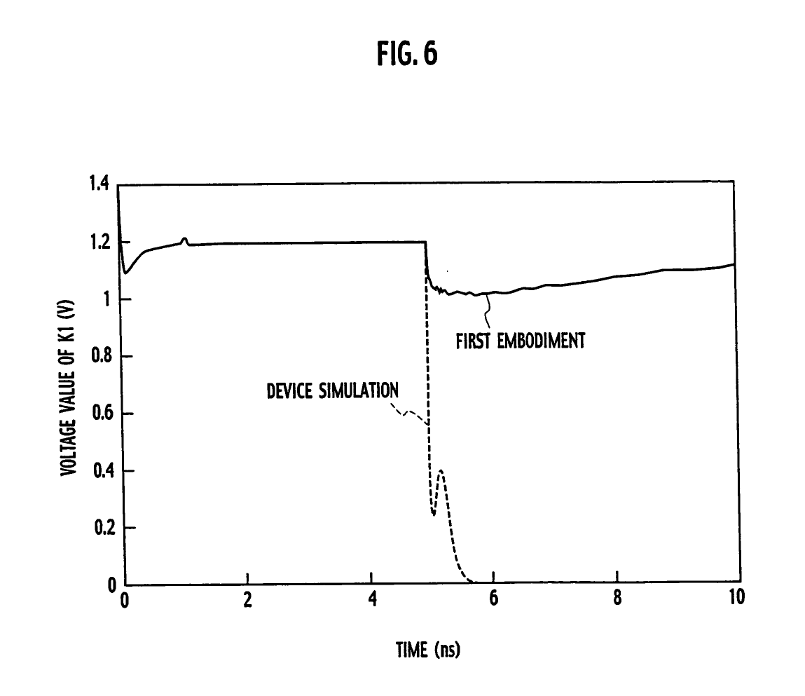

The results obtained by calculating voltage value of the connection node K1 when an alpha-ray is incident on the drain electrode of the nMOS transistor Q8 illustrated in FIG. 5 at time 5 ns is illustrated in FIG. 6. The results obtained by calculation with the evaluation method illustrated in FIG. 4 is illustrated with the solid line in FIG. 6. A voltage of 1.2 V is applied to the power supply terminals V1, V2 and V3 illustrated in FIG. 5, respectively. Furthermore, the graph illustrated by a dotted line in FIG. 6 is voltage value of the connection node K1 when the noise waveform obtained by device simulation of the nMOS transistor Q8 is applied to current supply to perform the calculation.

As illustrated in FIG. 6, the voltage value of the connection node K1 calculated by device simulation is inverted from 1.2 V to 0 V by the incidence of the alpha-ray at time 5 ns. However, from the result obtained by the evaluation method illustrated in FIG. 4, though the voltage value of the connection node K once decreases by the incidence of the alpha-ray, voltage value thereof returns thereafter to the voltage value before the incidence of the alpha-ray. This is because the noise waveform at the connection node K1 caused by the incidence of the alpha-ray is relaxed by input impedance viewed from the connection node K1, and because a logic inversion of voltage value of the connection node K1 is suppressed.

As described above, in the evaluation method according to the first embodiment, circuit simulation is executed by use of the calculation result of device simulation, and device simulation is further executed by use of the results of circuit simulation. Device simulation and circuit simulation are repeatedly executed until the difference between the simulation result of device simulation and the simulation result of circuit simulation satisfies the judgment condition. Thus, it is possible to obtain a result with high precision by allowing device simulation with high precision and circuit simulation, which is capable of simulating the semiconductor integrated circuit, to be in conjunction with each other.

A series of evaluation operations illustrated in FIG. 4 can be executed by controlling the evaluation system illustrated in FIG. 1, by use of an algorithm program equivalent to FIG. 4. Such a program is stored in the storage unit 20 constituting the evaluation system illustrated in FIG. 1. Furthermore, the program can execute the series of evaluation operations of the present invention by storing the program in a computer-readable recording medium and causing the storage unit 20 illustrated in FIG. 1 to read this recording medium.

Furthermore, before manufacture of the semiconductor integrated circuit, characteristics of a device used in the semiconductor integrated circuit is simulated by a process simulation and the like. Then, it is possible to execute the evaluation method illustrated in FIG. 4 by use of the simulation result as device information. It is possible to manufacture a device, for example, which allows the incidence of the alpha-ray to have little effect on the semiconductor integrated circuit, by reflecting the executed evaluation result on a device design.

Moreover, by reflecting the evaluation result by the evaluation method illustrated in FIG. 4 on the circuit design, it is possible to design a circuit, for example, which allows the incidence of the alpha-ray to have little effect.

### Second Embodiment

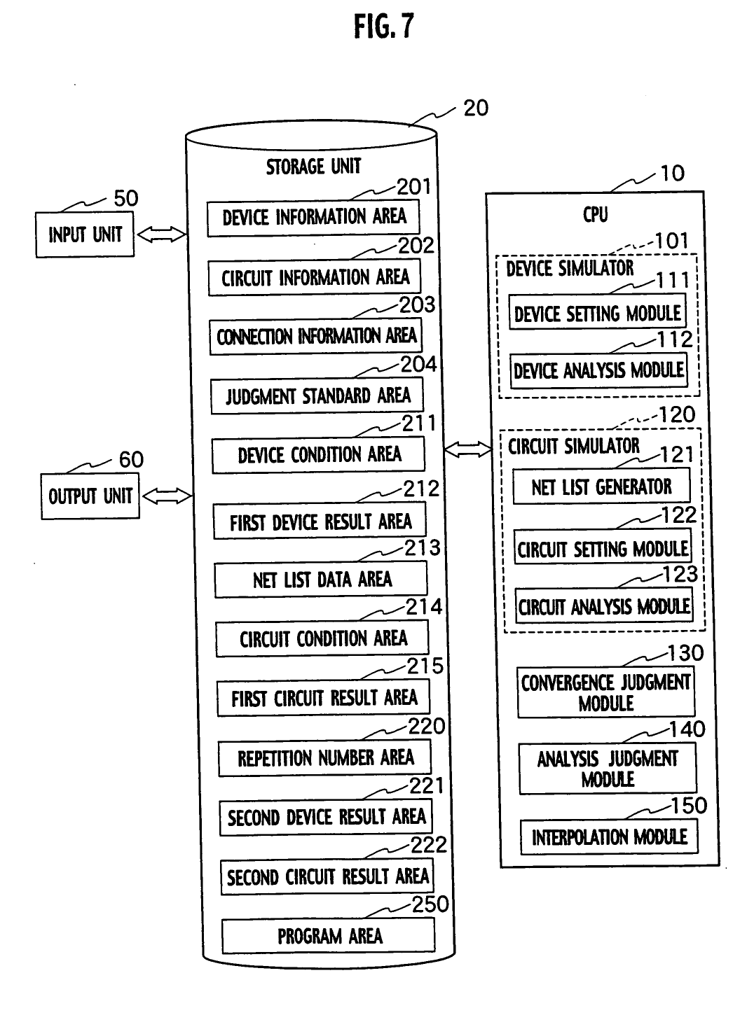

As illustrated in FIG. 7, an evaluation system according to a second embodiment of the present invention is different from the evaluation system illustrated in FIG. 1 in that the CPU 10 further includes an interpolation module 150, and the storage unit 20 further includes a repetition number area 220, a second device result area 222 and a second circuit result area 222.

The number of executions of the evaluation is stored in the repetition number area 220. Device simulation results at even-numbered times, for example, are stored in the second device result area 221. In addition, circuit simulation results at even-numbered times are stored in the second circuit result area 222. Then, device simulation results at odd-numbered times, for example, are stored in the first device result area 212. Furthermore, circuit simulation results at odd-numbered times are stored in the first circuit result area 215.

The interpolation module 150 reads the simulation results respectively stored in the first device result area 212, the first circuit result area 215, the second device result area 221 and the second circuit result area 222. Then, the interpolation module 150 performs an interpolation calculation, and extracts a current value of a connection node and a voltage value thereof, which are used in a device simulation.

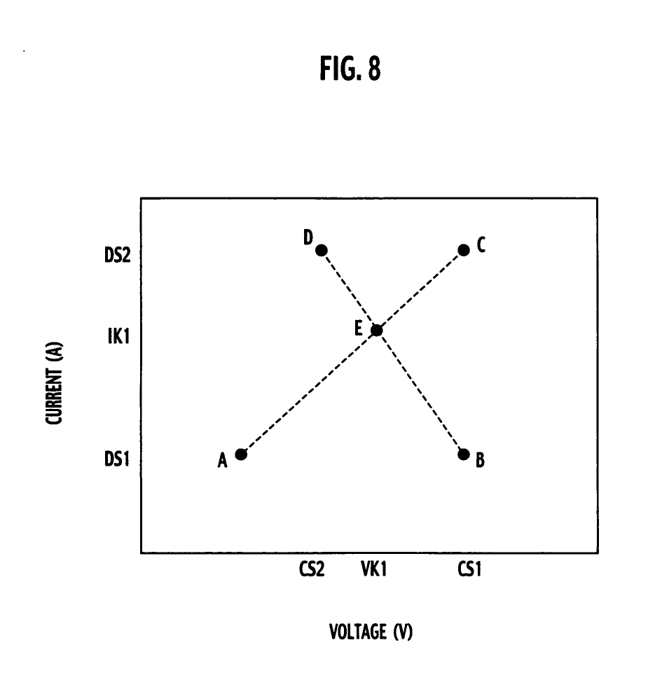

A method of interpolation calculation performed by the interpolation module 150 will be described with reference to FIG. 8 below. In the following descriptions, a case will be described where the current value of the device simulation results of the connection node is used for the circuit simulation results, and the voltage value of the circuit simulation results is used for device simulation. In addition, an operation of the interpolation module 150 at a stage where the n-th (n: an integer equal to 2 or more) evaluation has been completed will be described. For example, a first current value DS1 of a connection node calculated by a (n−1)-th device simulation is stored in the first device result area 212. A first voltage value CS1 of a connection node calculated by a (n−1)-th circuit simulation is stored in the first circuit result area 215. In addition, a second current value DS2 of a connection node calculated by an n-th device simulation is stored in the second device result area 221. Furthermore, a second voltage value of a connection node calculated by an n-th circuit simulation is stored in the second circuit result area 222.

The interpolation module 150 extracts an operation point A illustrated in FIG. 8 from the first current value DS1 of the connection node read from the first device result area 212 and from the voltage value of the connection node used when the (n−1)-th device simulation is executed. The voltage value of the connection node used when the (n−1)-th device simulation is executed is read from the device condition area 211. In addition, the interpolation module 150 extracts an operation point B from the first current value DS1 of the connection node and from the first voltage value CS1 of the connection node read from the first circuit result area 215. Furthermore, the interpolation module 150 extracts an operation point C from the first voltage value CS1 of the connection node and from the second current value DS2 of the connection node read from the second device result area 221. In a similar way, the interpolation module 150 extracts an operation point D from the second current value DS2 of the connection node and from second voltage value CS2 of the connection node read from the second circuit result area 222. Then, the interpolation module 150 extracts a voltage value VK1 and a current value IK1 at an intersection point E of a straight line connecting the operation points A and C and a straight line connecting the operation points B and D. The extracted voltage value VK1 and current value IK1 are used for device simulation in a (n+1)-th evaluation.

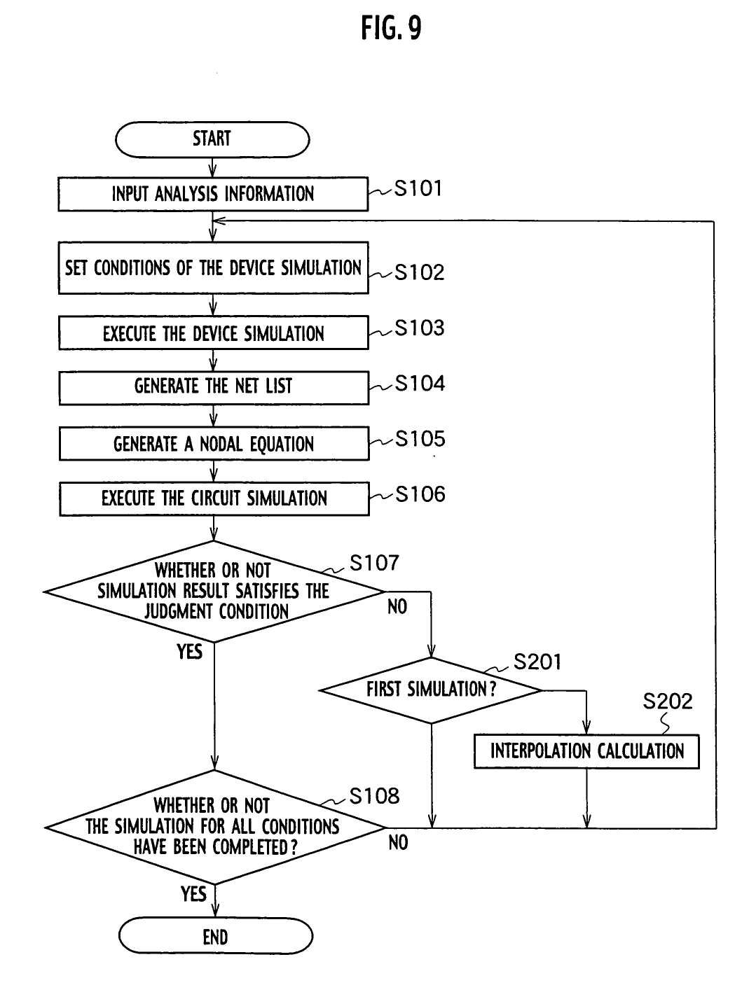

Next, an example of a method of evaluating the semiconductor integrated circuit by an evaluation system of FIG. 7 will be described using FIG. 9.

As in the case of the evaluation method according to the first embodiment, an evaluation of the latch circuit of FIG. 5 will be performed. In a Step S107 of FIG. 9, the difference between the voltage values of the connection nodes K1, K2 and K3 respectively calculated by device simulation and circuit simulation is compared with a judgment condition read by the convergence judgment module 130 from the judgment standard area 204. When the compared difference between the voltage values or the compared difference between the current values does not satisfy the judgment condition, the procedure progresses to a Step S201.

In the Step S201, the interpolation module 150 reads the number of executions of the evaluation from the repetition number area 220. When the number of executions of the evaluation is one, the interpolation module 150 stores the voltage values and current values of the connection nodes K1, K2 and K3 in the device condition area 211, which have been calculated by circuit simulation, and the procedure returns to the Step S103. When the number of executions of the evaluation is two or more, the procedure returns to a Step S202.

In the Step S202, the interpolation module 150 extracts the voltage values VK1 and the current values IK1 for the respective connection nodes K1, K2 and K3 by the interpolation calculation method already described above. Subsequently, the extracted voltage value VK1 and current value IK1 are stored in the device condition area 211, and the procedure returns to the Step S103. Then, the voltage values VK1 stored in the device condition area 211 are used as values of the voltage supplies of the lattice points corresponding to the connection nodes K1, K2 and K3, and device simulation is executed.

The voltage values VK1 and the current values IK1 extracted by the interpolation module 150 are calculated from the results of device simulation and circuit simulation, which have been performed immediately before. Therefore, the voltage values VK1 and the current values IK1 are predicted values of the voltage value and the current value of a connection node having a high possibility to satisfy the judgment condition. According to the evaluation method according to the second embodiment of the present invention, the time until the judgment condition is satisfied can be shortened by performing the interpolation calculation. The second embodiment is substantially the same as the first embodiment in other respects, and overlapped descriptions are omitted.

### Third Embodiment

An evaluation system according to a third embodiment of the present invention is different from the semiconductor evaluation system illustrated in FIG. 1 in that the evaluation system of this embodiment further includes a measuring unit 70. Furthermore, the CPU 10 further includes a measurement module 160 and a parameter extraction module 170, and the storage unit 20 further includes a measurement condition area 230 and a measurement result area 231.

The measuring unit 70 is constituted by a power supply such as a constant current supply and a constant voltage supply, an LSI tester functioning as an ammeter and a voltmeter, and a prober, which are not illustrated. The measurement unit 70 measures the latch circuit, the nMOS transistor and the like. The measuring unit 70 is controlled by the measurement module 160. The parameter extraction module 170 extracts information necessary for device simulation or circuit simulation from the measurement results. Conditions of measurements performed by the measuring unit 70 are stored in the measurement condition area 230. Results of the measurement performed by the measuring unit 70 are stored in the measurement result area 231.

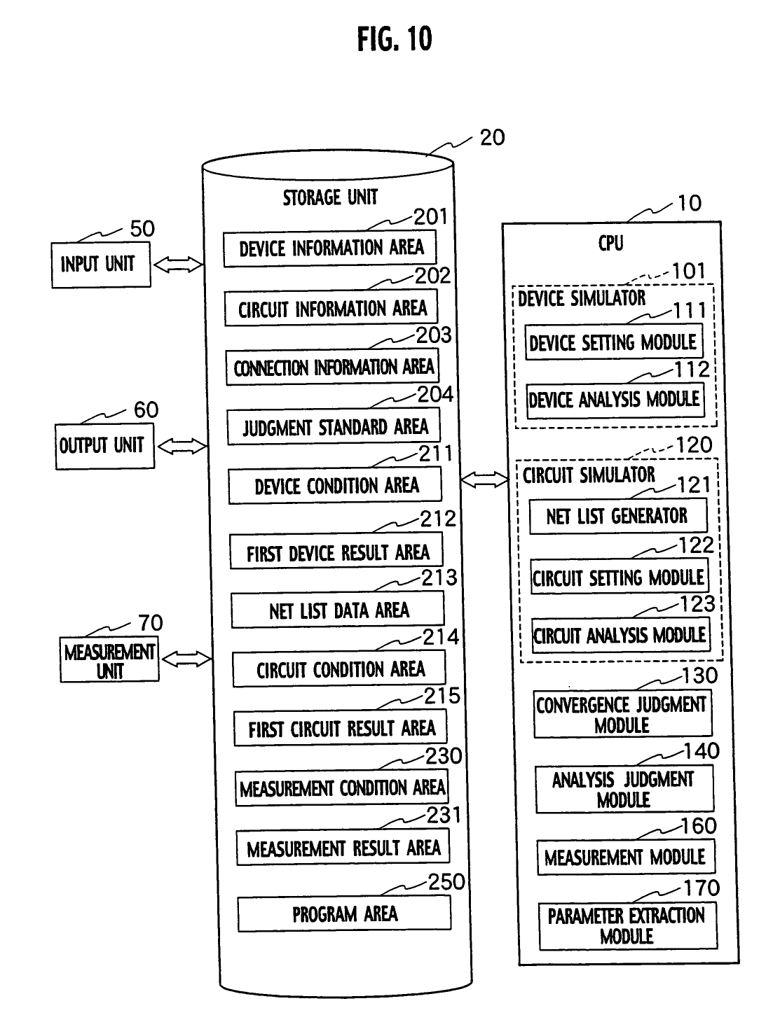

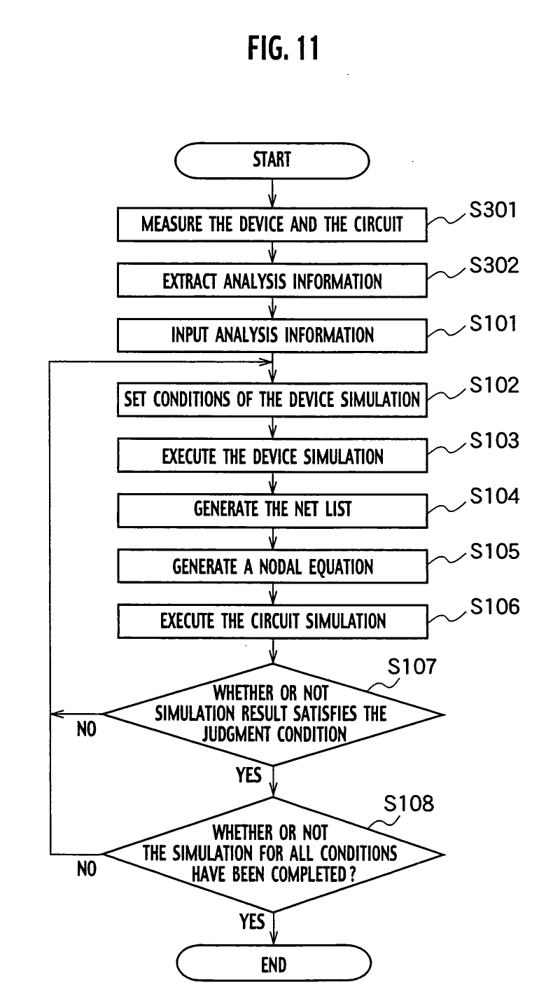

An example of the method of evaluating the semiconductor integrated circuit by the evaluation system illustrated in FIG. 10 will be described by use of the flowchart illustrated in FIG. 11 and the latch circuit illustrated in FIG. 5.

In Step S301, the measurement module 160 illustrated in FIG. 10 reads the measurement conditions stored in the measurement condition area 230. Based on the measurement conditions, the measurement module 160 performs measurements for the latch circuit, the nMOS transistor Q8 and the like, which are illustrated in FIG. 5, by the controlling measurement unit 70. The measurement results are stored in the measurement result area 231.

In Step S302, the parameter extraction module 170 reads the measurement results stored in the measurement result area 231. Then, the parameter extraction module 170 extracts information necessary for device simulation of the nMOS transistor Q8 and circuit simulation of the latch circuit illustrated in FIG. 5 from the measurement results. The extracted results are stored in the device information area 201 and the circuit information area 202.

Thereafter, the evaluation is performed in a similar manner to the evaluation method according to the first embodiment.

According to the evaluation method according to the third embodiment illustrated in FIG. 11, information necessary for the evaluation of the circuit is extracted from the measurement results measured by the measurement unit 70. Therefore, it is possible to shorten the time from the acquisition of device information and circuit information to performance of the evaluation. The third embodiment is substantially the same as the first embodiment in other respects, and overlapped descriptions are omitted.

### Other Embodiments

In the description of the first embodiment already described above, though the evaluation method using the MOS transistor was described, circuits using other semiconductor devices such as a bipolar transistor may also be adopted. In addition, though the case where a single device of the circuit for executing device simulation was described, it is possible for a plurality of devices to perform device simulation.

Various modifications will become possible for those skilled in the art after receiving the teachings of the present disclosure without departing from the scope thereof.

1. A computer implemented method for evaluating a semiconductor integrated circuit, comprising:
executing a device simulation of a plurality of devices included in a semiconductor integrated circuit based on device information of the devices to acquire device simulation values;
executing a circuit simulation to acquire circuit simulation values of the semiconductor integrated circuit by generating a net list using the device simulation values as values of a power supply of connection nodes based on circuit information of the semiconductor integrated circuit and connection node information; and
repeating the device simulation and the circuit simulation until differences between the device simulation values and the circuit simulation values of the connection nodes satisfy judgment conditions, so as to set conditions of the device simulation employing the circuit simulation values for the values of the power supply of the connection nodes.

2. The method of claim 1, wherein the device simulation values represent characteristics of the each of the devices at a plurality of lattice points, which are generated by dividing a space occupied by the device.

3. The method of claim 2, wherein the characteristics represent voltage values of the lattice points.

4. The method of claim 1, wherein the circuit simulation values represent characteristics at a plurality of connection nodes between the devices included in the semiconductor integrated circuit.

5. The method of claim 4, wherein the characteristics represent voltage values of the connection nodes.

6. The method of claim 1, wherein the circuit simulation values employed for the setting conditions of the device simulation are current values.

7. The method of claim 1, wherein the values of the power supply of the connection nodes for the device simulation are calculated based on the device simulation values obtained by executing the device simulation a plurality of times and the circuit simulation values obtained by executing the circuit simulation a plurality of times.

8. The method of claim 1, further comprising:
measuring characteristics of the devices; and
extracting the device information of each of the devices based on the measured characteristics.

9. The method of claim 1, further comprising:
measuring a characteristic of the semiconductor integrated circuit; and
extracting the circuit information of the semiconductor integrated circuit based on the measured characteristic.

10. A system for evaluating a semiconductor integrated circuit, comprising:
a device simulator configured to execute a device simulation of a plurality of devices included in a semiconductor integrated circuit based on device information of the devices to acquire device simulation values;
a circuit simulator configured to execute a circuit simulation to acquire circuit simulation values of the semiconductor integrated circuit by generating a net list using the device simulation values as values of power supply of connection nodes based on circuit information of the semiconductor integrated circuit and connection node information; and
a convergence judgment module configured to judge on determines whether differences between the device simulation values and the circuit simulation values of the connection nodes satisfy judgment conditions and to repeat the device simulation and the circuit simulation until the differences satisfy the judgment conditions, so as to set conditions of the device simulation employing the circuit simulation values as the values of the power supply of the connection nodes.

11. The system of claim 10, wherein the device simulator comprises:
a device setting module configured to set conditions for executing the device simulation by dividing a space occupied by the device into a lattice; and
a device analysis module configured to analyze characteristics of the device at lattice points.

12. The system of claim 11, wherein the characteristics represent voltage values of the lattice points.

13. The system of claim 10, wherein the circuit simulator comprises:
a net list generator configured to generate the net list;
a circuit setting module configured to set conditions for executing the circuit simulation by generating a nodal equation based on the net list; and
a circuit analysis module configured to analyze characteristics of the semiconductor integrated circuit by solving the nodal equation to acquire the circuit simulation values.

14. The system of claim 13, wherein the circuit simulation values represent characteristics at a plurality of connection nodes between the devices included in the semiconductor integrated circuit.

15. The system of claim 10, wherein the circuit simulation values employed for the setting conditions of the device simulation are current values.

16. The system of claim 10, further comprising an interpolation module configured to calculate the values of the power supply of the connection nodes employed for the device simulation, based on the device simulation values obtained by executing device simulation a plurality of times and the circuit simulation values obtained by executing the circuit simulation a plurality of times.

17. The system of claim 10, further comprising a measuring unit configured to measure characteristics of the devices and characteristics of the semiconductor integrated circuit.

18. The system of claim 17, further comprising a parameter extraction module configured to extract the device information and the circuit information from the results measured by the measuring unit.

19. A computer program product for evaluating a semiconductor integrated circuit, comprising:
instructions configured to execute a device simulation of a plurality of devices included in a semiconductor integrated circuit based on device information of the devices to acquire device simulation values;
instructions configured to execute a circuit simulation to acquire circuit simulation values of the semiconductor integrated circuit by generating a net list using the device simulation values as values of power supply of connection nodes based on circuit information of the semiconductor integrated circuit and connection node information; and
instructions configured to repeat the device simulation and the circuit simulation until differences between the device simulation values and the circuit simulation values of the connection nodes satisfy judgment conditions, so as to set conditions of the device simulation employing the circuit simulation values as the values of the power supply of the connection nodes.
